(19) United States
(12) Patent Application Publication
(10) Pub. No.: US 2018/0173037 A1
(43) Pub. Date: Jun. 21, 2018

(54) LIQUID CRYSTAL DISPLAY, DISPLAY MODULE THEREOF, AND THIN FILM TRANSISTOR ARRAY SUBSTRATE

(71) Applicant: Shenzhen China Star Optoelectronics Technology Co., Ltd., Shenzhen, Guangdong (CN)

(72) Inventor: Sikun HAO, Shenzhen (CN)

(73) Assignee: Shenzhen China Star Optoelectronics Technology Co. , Ltd., Shenzhen, Guangdong (CN)

(21) Appl. No.: 15/123,643

(22) PCT Filed: Jul. 5, 2016
(86) PCT No.: PCT/CN2016/088496

§ 371 Date: Sep. 4, 2016

(30) Foreign Application Priority Data
Jun. 1, 2016 (CN) 2016103797113

(51) Int. Cl. G02F 1/1333; G02F 1/1343; G02F 1/1362; G06F 3/041

(52) U.S. Cl. CPC G02F 1/13338; G02F 1/1343; G02F 2001/1635; G06F 3/0412; G02F 1/136286

(57) ABSTRACT

The present disclosure proposes a liquid crystal display (LCD), a liquid crystal display module, and a thin film transistor (TFT) array substrate. The TFT array substrate includes a plurality of array units. Each of array units includes a pixel electrode, a common electrode, and two TFTs. One terminal of each of the two TFTs are connected to a data line and a gate line respectively, and the other terminal of each of the two TFTs are connected to the pixel electrode. One of the two TFTs is configured to control display of an image, and the other TFT is configured to control the touch function.

### BACKGROUND

### 1. Field of the Invention

The present invention relates to the field of liquid crystal display, and more particularly, to a liquid crystal display (LCD), an LCD display module, and a thin film transistor (TFT) array substrate.

### 2. Description of the Prior Art

More and more advanced-function displays have found their applications in current consumer electronic products. In particular, liquid crystal displays (LCDs) having a high-resolution color screen, are more widely applied in various electronic devices, such as televisions, mobile phones, personal digital assistances (PDA), digital cameras, desktop computer screens, and notebook computer screens.

In-plate switching (IPS) is a kind of wide visual angle technology. With IPS liquid crystal display, a viewer can only see a short axis of liquid crystal molecules anytime, so the images viewed by the viewer at any angles are of no much difference. It is really a better improvement of the visual angle of the LCD. To modify the errors in a twisted nematic (TN) mode and to obtain a better visual angle, a brand-new liquid crystal alignment is realized by the first-generation IPS technology. A Y-shaped electrode is used and a dual-domain mode is introduced in the second-generation super-IPS (S-IPS) technology to improve the phenomenon of grayscale inversion at some specific angles in the IPS mode. To make the brightness increase, the distance of the liquid crystal molecules is shortened, and an aperture rate is enhanced in the third-generation advanced super-IPS (AS-IPS) technology.

Please refer to FIG. 1 and FIG. 2. FIG. 1 is a schematic diagram of a conventional pixel electrode structure and a driving method of the pixel electrode structure. FIG. 2 is a schematic diagram of the TFT array substrate in the pixel electrode structure as shown in FIG. 1. The pixel electrode structure comprises a thin film transistor (TFT) 1, a data line 2, a gate line 3, a common electrode 4, and a pixel electrode 5. A shortcoming of the pixel electrode structure is that the touch function does not work on the pixels.

### SUMMARY

An object of the present invention is to propose an LCD, an LCD display module, and a TFT array substrate to solve the technical problem that the conventional liquid crystal display array substrate does not have the touch function.

According to the one embodiment of the preferred embodiment of the present disclosure, a TFT array substrate includes a plurality of array units. Each of array units includes a pixel electrode, a common electrode, and two TFTs. One terminal of each of the two TFTs are connected to a data line and a gate line respectively, and the other terminal of each of the two TFTs are connected to the pixel electrode. One of the two TFTs is configured to control display of an image, and the other TFT is configured to control the touch function.

According to one preferred embodiment, the two TFTs are connected to the same data line.

According to another preferred embodiment, the two TFTs are connected to different data lines

According to another preferred embodiment, and the two TFTs are connected to the different gate lines.

According to another preferred embodiment, the two TFTs are arranged at both sides of the array unit, respectively.

According to still another preferred embodiment, the two TFTs are arranged at the same side of the array unit.

According to yet another preferred embodiment, different driving methods are applied to the two TFTs.

According to the claimed invention, a liquid crystal display module includes a thin film transistor (TFT) array substrate as provided in any one of the above embodiments.

According to the claimed invention, a liquid crystal display includes a liquid crystal display module as provided in the above embodiment.

Compared with the conventional technology, the LCD, the LCD display module, and the TFT array substrate are proposed by the present invention. In the present invention, two TFTs are arranged and connected to different gate lines to control the display of images and the touch function, respectively, to further realize that the LCD pixels has the touch function.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional pixel electrode structure and a driving method of the pixel electrode structure.

FIG. 2 is a schematic diagram of the TFT array substrate in the pixel electrode structure as shown in FIG. 1.

FIG. 3 is a schematic diagram of a pixel electrode structure of a touch unit and a driving method of the pixel electrode structure in a thin film transistor (TFT) array substrate according to a first embodiment of the present invention.

FIG. 4 is a schematic diagram of the TFT array substrate in the pixel electrode structure as shown in FIG. 3.

FIG. 5 is a schematic diagram of a pixel electrode structure of a touch unit and a driving method of the pixel electrode structure in a thin film transistor (TFT) array substrate according to a second embodiment of the present invention.

FIG. 6 is a schematic diagram of the TFT array substrate in the pixel electrode structure as shown in FIG. 5.

FIG. 7 shows a sequence diagram of driving the TFT array substrate according to the embodiment of the present invention.

FIG. 8 is a schematic diagram of the structure of the LCD according to one preferred embodiment of the present invention.

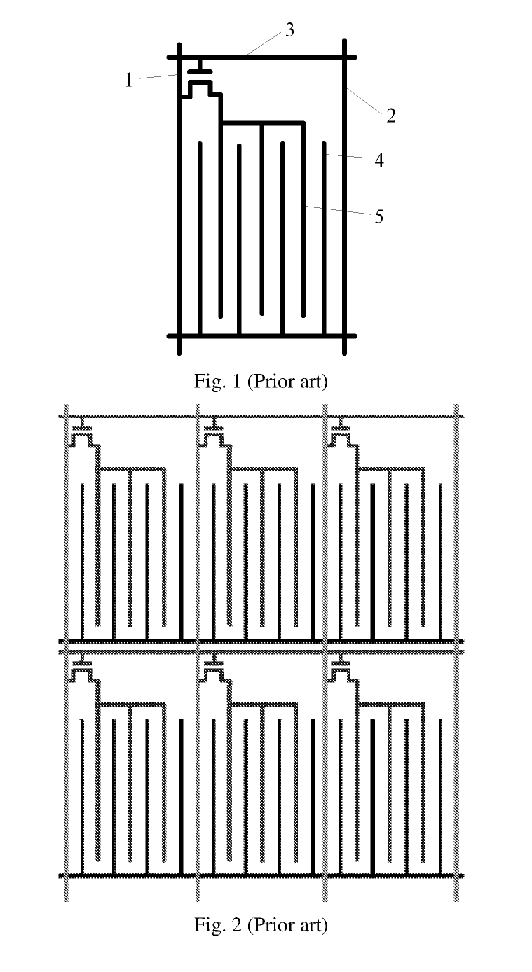

### DETAILED DESCRIPTION OF THE PREFERRED EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

### Embodiment 1

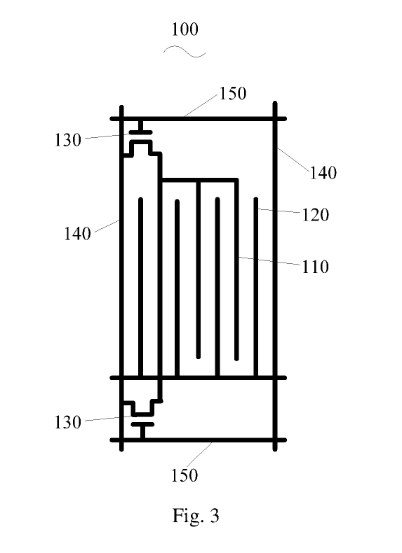

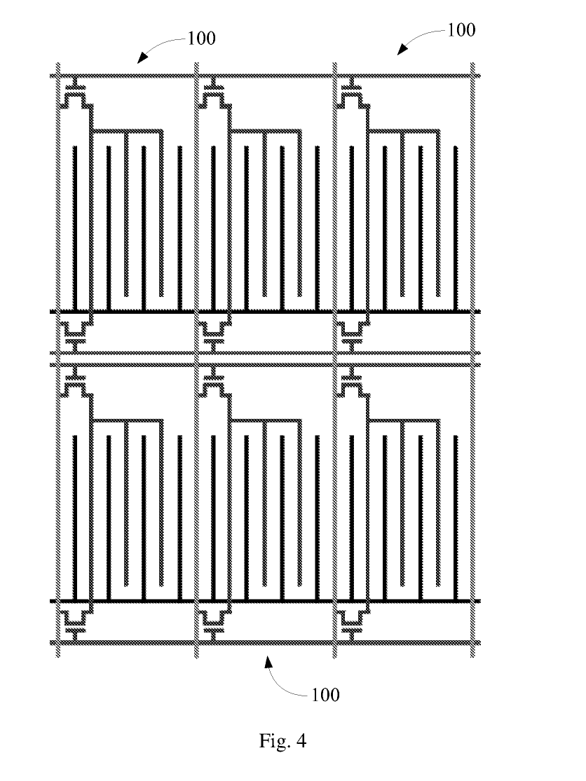

Please refer to FIG. 3 and FIG. 4. FIG. 3 is a schematic diagram of a pixel electrode structure of a touch unit and a driving method of the pixel electrode structure in a thin film transistor (TFT) array substrate according to a first embodiment of the present invention. FIG. 4 is a schematic diagram of the TFT array substrate in the pixel electrode structure as shown in FIG. 3. The TFT array substrate comprises a plurality of array units 100.

Each of the plurality of array units 100 comprises a pixel electrode 110, a common electrode 120, and two thin film transistors (TFTs) 130. One terminal of each of the TFTs 130 is connected to a data line 140 and a gate line 150 respectively, and the other terminal of each of the TFTs 130 is connected to the pixel electrode 110. One of the TFTs 130 is used to control the display of images, and the other TFT 130 is used to control the touch function.

In this embodiment, the two TFTs 130 are connected to the same data line 140. The two TFTs 130 are connected to the different gate lines 150. The two TFTs 130 are arranged at both sides of the array unit, respectively.

### Embodiment 2

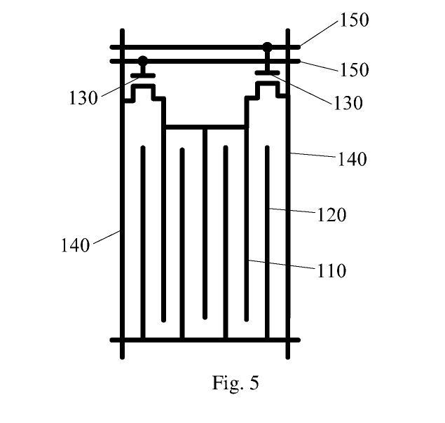

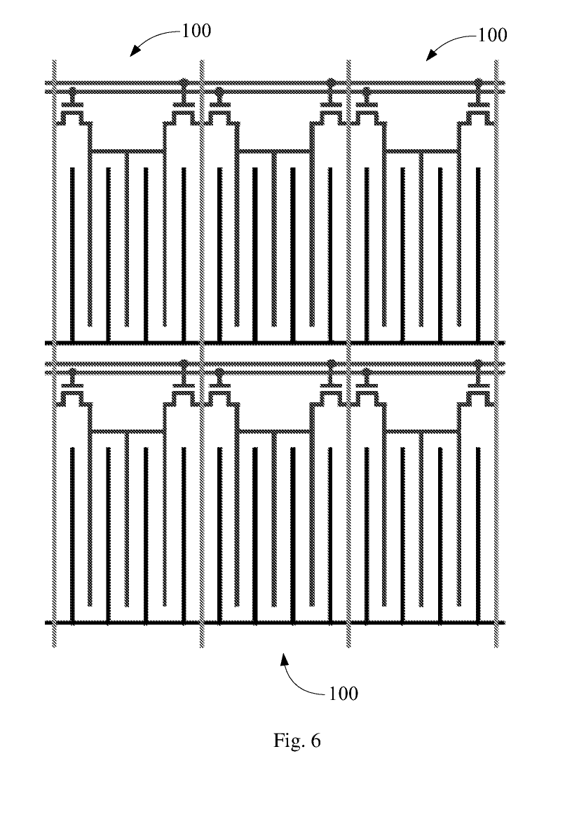

Please refer to FIG. 5 and FIG. 6. FIG. 5 is a schematic diagram of a pixel electrode structure of a touch unit and a driving method of the pixel electrode structure in a thin film transistor (TFT) array substrate according to a second embodiment of the present invention. FIG. 6 is a schematic diagram of the TFT array substrate in the pixel electrode structure as shown in FIG. 5. The TFT array substrate comprises a plurality of array units 100.

Each of the plurality of array units 100 comprises a pixel electrode 110, a common electrode 120, and two TFTs 130. One terminal of each of the TFTs 130 is connected to a data line 140 and a gate line 150 respectively, and the other terminal of each of the TFTs 130 is connected to the pixel electrode 110. One of the TFTs 130 is used to control the display of images, and the other TFT 130 is used to control the touch function.

In this embodiment, the two TFTs 130 are connected to the different data lines 140. The two TFTs 130 are connected to the different gate lines 150 as well. The two TFTs 130 are arranged at the same side of the array unit.

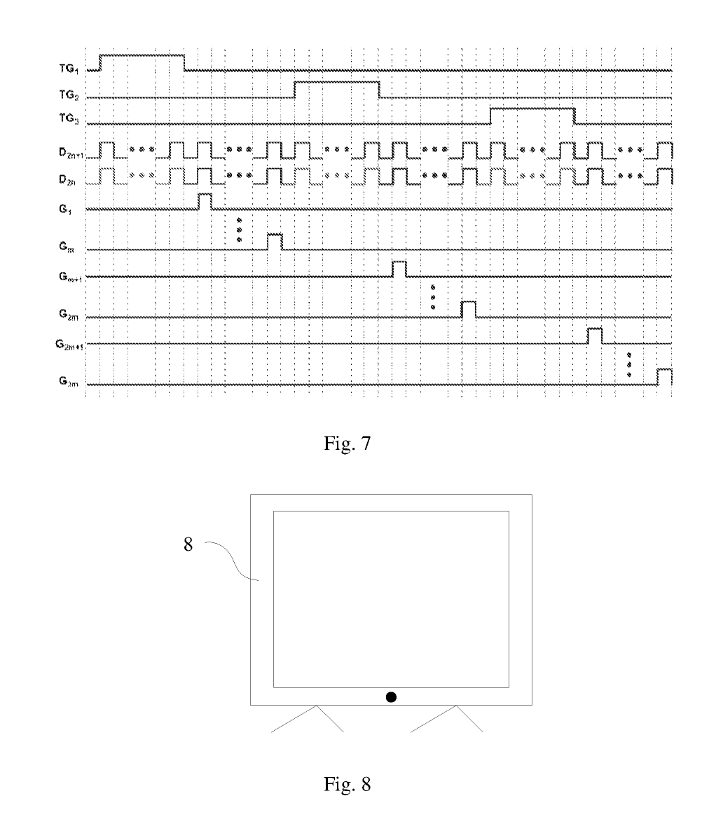

Preferably, different driving methods are applied to the two TFTs 130. Please refer to FIG. 7 showing a sequence diagram of driving the TFT array substrate according to the embodiment of the present invention. The process of driving the TFT array substrate is as follows: A certain zone is touched and scanned. Then, an image is shown after the zone completes the scanning. Next, another zone is touched and scanned. Then, an image is shown after the zone completes the scanning. After all, the display screen completes the process of being touched, and an image notifying of completion is shown.

TG₁, TG₂, and TG₃ are gate line signals of a first kind and are used to control the touch of the TFT 130. G₁, G₂, and G₃ are gate line signals of a second kind and are used to control the image display of the TFT 130. D₁, D₂, and D₃ are data line signals and are used to control the input or output of a touch signal or an image signal. When D₁, D₂, and D₃ are used to control the touch signal, an odd strip is taken as Tx, and an even strip is taken as Rx. TG and G indicates that the two TFTs 130 are driven. TG and G do not have a specifically corresponding relationship with the two TFTs 130 as shown in FIG. 3 and FIG. 5. The corresponding relationship between TG and G and the two TFTs 130 can exchange.

Compared with the conventional technology, the present invention proposes the TFT array substrate where the two TFTs are arranged in each of the plurality of array units and connected to different gate lines to control the display of images and the touch function, respectively, to further realize that the LCD pixels has the touch function.

Further, a liquid crystal display module and a liquid crystal display (LCD) where the liquid crystal display module is adopted are proposed by the present invention. The liquid crystal display module comprises a thin film transistor (TFT) array substrate with the touch function as described in the embodiments of the present invention. Please refer to FIG. 8. FIG. 8 is a schematic diagram of the structure of the LCD according to one preferred embodiment of the present invention. The LCD comprises a cell 8 where the liquid crystal display module as described in the embodiments is arranged. The technical characteristics of the TFT array substrate with the touch function can refer to the embodiments of the present invention. As for the technical characteristics of the other components arranged in the LCD, one person skilled in the art is supposed to fully understand. So, the technical characteristics of these components are not detailed here.

Compared with the conventional technology, the LCD, the LCD display module, and the TFT array substrate are proposed by the present invention. In the present invention, two TFTs are arranged and connected to different gate lines to control the display of images and the touch function, respectively, to further realize that the LCD pixels has the touch function.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A thin film transistor (TFT) array substrate with a touch function, comprising: a plurality of array units; each of the plurality of array units comprising a pixel electrode, a common electrode, and two TFTs; one terminal of each of the two TFTs being connected to a data line and a gate line respectively, and the other terminal of each of the two TFTs being connected to the pixel electrode; one of the two TFTs being configured to control display of an image, and the other TFT being configured to control the touch function; the two TFTs being connected to the same data line, and the two TFTs being connected to the different gate lines.

2. The TFT array substrate of claim 1, wherein the two TFTs are arranged at both sides of the array unit, respectively.

3. The TFT array substrate of claim 1, wherein the two TFTs are arranged at the same side of the array unit.

4. The TFT array substrate of claim 1, wherein different driving methods are applied to the two TFTs.

5. A liquid crystal display module, comprising a thin film transistor (TFT) array substrate, the TFT array substrate comprising a plurality of array units; each of the plurality of array units comprising a pixel electrode, a common electrode, and two TFTs; one terminal of each of the two TFTs being connected to a data line and a gate line respectively, and the other terminal of each of the two TFTs being connected to the pixel electrode; one of the two TFTs being configured to control display of an image, and the other TFT being configured to control the touch function.

6. The liquid crystal display module of claim 5, wherein the two TFTs are connected to the same data line.

7. The liquid crystal display module of claim 5, wherein the two TFTs are connected to different data lines

8. The liquid crystal display module of claim 5, wherein and the two TFTs are connected to the different gate lines.

9. The liquid crystal display module of claim 8, wherein the two TFTs are arranged at both sides of the array unit, respectively.

10. The liquid crystal display module of claim 8, wherein the two TFTs are arranged at the same side of the array unit.

11. The liquid crystal display module of claim 8, wherein different driving methods are applied to the two TFTs.

12. A liquid crystal display (LCD), comprising a liquid crystal display module comprising a thin film transistor (TFT) array substrate, the TFT array substrate comprising a plurality of array units; each of the plurality of array units comprising a pixel electrode, a common electrode, and two TFTs; one terminal of each of the two TFTs being connected to a data line and a gate line respectively, and the other terminal of each of the two TFTs being connected to the pixel electrode; one of the two TFTs being configured to control display of an image, and the other TFT being configured to control the touch function.

13. The liquid crystal display of claim 12, wherein the two TFTs are connected to the same data line.

14. The liquid crystal display of claim 12, wherein the two TFTs are connected to different data lines

15. The liquid crystal display of claim 12, wherein and the two TFTs are connected to the different gate lines.

16. The liquid crystal display of claim 15, wherein the two TFTs are arranged at both sides of the array unit, respectively.

17. The liquid crystal display of claim 15, wherein the two TFTs are arranged at the same side of the array unit.

18. The liquid crystal display of claim 15, wherein different driving methods are applied to the two TFTs.
